(19) United States
(12) Patent Application Publication
(10) Pub. No.: US 2025/0145826 A1
(43) Pub. Date: May 8, 2025

(54) THERMALLY CONDUCTIVE COMPOSITION AND A PRODUCTION METHOD OF A THERMAL CONDUCTIVE COMPONENT USING THE COMPOSITION

(71) Applicant: Wacker Chemie AG, Munich (DE)

(72) Inventors: Kazuya SAKAI, Chikusei-shi (JP); Shunsuke YAMADA, Chikusei-shi (JP)

(73) Assignee: Wacker Chemie AG, Munich (DE)

(21) Appl. No.: 18/837,902

(22) PCT Filed: Mar. 14, 2023
(86) PCT No.: PCT/EP2023/056503

§ 371 Date: Aug. 13, 2024

(30) Foreign Application Priority Data
Apr. 6, 2022 (JP) 2022-063186

(51) Int. Cl. C08L 83/04; C08K 3/04; C08K 3/20; C08K 3/22

(52) U.S. Cl. CPC C08L 83/04; C08K 3/04; C08K 3/20; C08K 2003/2227; C08K 2201/001; C08K 2201/014

(57) ABSTRACT

A thermally conductive composition includes a component (A) that is a diorganopolysiloxane having an alkenyl group bonded to a silicon atom, a component (B) that is a diorganopolysiloxane having a hydrogen atom bonded to a silicon atom, a component (C) that is expandable graphite, a component (D) that is a thermally conductive filler, a component (E) that is an addition reaction catalyst, an organosilicon compound or an organosiloxane (also referred to as a silane coupling agent) that produces silanols by hydrolysis, and a condensation catalyst. The expansion rate (volume after high temperature exposure/volume before high temperature exposure) of a thermally conductive member obtained by curing the thermally conductive composition is 1.1 or less.

### TECHNICAL FIELD

The present invention relates to a thermally conductive composition containing a thermally conductive filler and expandable graphite, and a method for producing a thermally conductive member using the composition.

### BACKGROUND ART

As electronic components become smaller, higher in performance, and higher in output, the emitted thermal energy tends to increase, and the temperature of the electronic components tends to increase. In recent years, along with the popularization of environmentally friendly electric vehicles, high-performance batteries have been developed. In view of this background, various heat-dissipating silicone products have been developed for transferring heat generated by a heat generating body such as electronic components and batteries to a heat dissipation member such as a heat sink.

The heat-dissipating silicone products include those provided in a sheet form such as a heat dissipation sheet and those provided in a liquid form such as a gap filler.

The heat dissipation sheet is a flexible and highly thermally conductive silicone rubber sheet obtained by curing a thermally conductive silicone composition into a sheet form. Therefore, such a heat dissipation sheet can be easily installed to come into close contact with the surface of a component, thereby enhancing the heat dissipation properties. On the other hand, the gap filler is obtained by applying a liquid or paste thermally conductive silicone composition directly to a heat generating body or a heat dissipating body, and curing the composition after the application. Therefore, the use of a gap filler is advantageous in that even when the filler is applied to a complicated irregular shape, voids will be filled and a high heat dissipation effect will be exhibited.

Under such circumstances, many compositions have been developed for forming a heat dissipation sheet or a gap filler with improved adhesive properties to a battery cell or module.

For example, Patent Literature 1 (=PTL) discloses a thermally conductive silicone adhesive composition that exhibits good adhesive properties relative to an organic resin.

Patent Literature 2 describes a gap filler that is firm when cured.

Patent Literature 3 describes a thermally conductive polyurethane adhesive with an excellent combination of mechanical properties.

### CITATION LIST

### Patent Literature

PTL 1: Japanese Patent Application Laid-Open No. 2014-224189
PTL 2: Japanese Translation of PCT Patent Application Publication No. 2021-523965 (corresponding to WO2019/220287)
PTL 3: Japanese Patent Application Laid-Open No. 2021-507067 (corresponding to WO2019/120924)

### SUMMARY OF INVENTION

### Technical Problem

Since all of the compositions described in the above literatures are firm when cured, they cannot be expected to exhibit followability during the expansion of the battery cell at an extremely high temperature, resulting in a problem of deforming or damaging the battery cell.

When the battery cell becomes extremely hot or catches fire, the battery cell may expand due to heating. Even when such expansion occurs, the battery cell in which a flexible material such as a PET film is used in the exterior of the battery cell may be equipped with elasticity for such an expansion caused by heating.

However, if the adhesive strength between the thermally conductive member such as a heat dissipation sheet or a gap filler and the exterior is strong, the thermally conductive member may fail to cope with the flexibility of the exterior at the time of the expansion of the battery cell, resulting in damage to the exterior of the cell. Furthermore, if the adhesive strength of the thermally conductive material is strong when some form of impact is applied to a battery cell that has expanded due to exposure to an extremely high temperature, the battery cell and its exterior may be damaged in the same manner as described above. If the battery cell is damaged, a leakage of the liquid inside the battery may cause an explosion of the battery cell or the like, thereby posing a significant safety risk to the user and the like.

Under the above circumstances, an object of the present invention is to provide a thermally conductive member which exhibits good adhesion/adhesive properties to a substrate such as a heat-generating body or a heat-dissipating body and excellent heat dissipation properties due to its high thermal conductivity, the thermally conductive member being capable of reducing deformation of the substrate by reducing the adhesive properties to the substrate at an extremely high temperature.

### Solution to Problem

The present inventors have found that the problems of the present invention can be solved by mixing a thermally conductive filler and expandable graphite in a silicone composition including an organopolysiloxane, thereby completing the present invention.

A thermally conductive composition according to the present invention contains:
a component (A) that is a diorganopolysiloxane having an alkenyl group bonded to a silicon atom;
a component (B) that is a diorganopolysiloxane having a hydrogen atom bonded to a silicon atom;
a component (C) that is expandable graphite;
a component (D) that is a thermally conductive filler; and
a component (E) that is an addition reaction catalyst, wherein
the content of the component (C) is 0.5 parts by mass or more and 5 parts by mass or less relative to 100 parts by mass of the total amount of the components (A) and (B), and
the content of the component (D) is 300 parts by mass or more and 2,000 parts by mass or less relative to 100 parts by mass of the total amount of the components (A) and (B).

The thermally conductive composition of the present invention (hereinafter, also simply referred to as a composition) is necessarily a composition for forming a thermally conductive member, and examples of the thermally conductive member include a heat dissipation sheet and a gap filler.

In the case of a heat dissipation sheet, the thermally conductive composition is cured into a sheet shape to form a heat dissipation sheet, which is then used by being adhered to a heat generating body (substrate) such as a battery cell or module.

In the case of a gap filler, the thermally conductive composition in a liquid form is applied onto a substrate. After being applied onto the substrate, the thermally conductive composition is cured by a cross-linking reaction to obtain a gap filler.

In such an application, the thermally conductive member and the substrate are strongly adhered to each other due to an interaction such as hydrogen bonding between an alkenyl group or an SiOH group included in the thermally conductive composition and a carbonyl group or a OH group on a surface of the substrate.

The thermally conductive composition contains 300 parts by mass or more of the thermally conductive filler as the component (D) relative to 100 parts by mass of the total amount of the components (A) and (B). Thus, the thermally conductive member has sufficiently high thermal conductive properties and also exhibits high heat dissipation properties due to the high thermal conductive properties and adhesion.

Furthermore, the content of the expandable graphite as the component (C) is in a low content range of 0.5 parts by mass or more and 5 parts by mass or less relative to 100 parts by mass of the total amount of the components (A) and (B). Thus, the resulting thermally conductive member has high insulating properties and is useful as a thermally conductive member used in an electronic member. Furthermore, setting the added amount of the expandable graphite within the above-mentioned range makes it possible to keep the mixing viscosity of the thermally conductive composition (viscosity when all components have been mixed into the thermally conductive composition) low and inject the thermally conductive composition into a fine gap. Thus, the thermally conductive composition is particularly useful as a thermally conductive gap filler composition for forming a gap filler. Also, for this reason, a gap filler having high adhesion to a substrate and good thermal conductive properties can be obtained.

If the thermally conductive member is exposed to a high temperature after curing (e.g., at a temperature of 250° C. or higher for 1 hour or longer), an inter-layer substance such as sulfuric acid that is intercalated between layers of the expandable graphite as the component (C) is decomposed and gasified by heating. The resulting gasification pressure causes each layer to expand in the vertical direction and, at the same time, causes a cohesive failure of the thermally conductive member itself or breaks the hydrogen bonds between the substrate and the gap filler.

The expandable graphite before exposure to a high temperature has a small specific surface area and is resistant to cohesive failure. Thus, the thermally conductive member exhibits high adhesion to the substrate. In contrast, after exposure to a high temperature, the occurrence of the cohesive failure reduces the cohesive force of the thermally conductive member itself or the adhesion between the thermally conductive member and the substrate. Due to this phenomenon, the thermally conductive member that was adhered to the substrate is peeled off from the surface of the substrate.

The above-mentioned mechanism makes it possible to reduce damage or deformation of the exterior or the battery cell caused by being firmly adhered by the thermally conductive member, even when the battery cell expands due to a high temperature or the exterior of the battery cell expands or shrinks.

In this configuration, the added amount of the expandable graphite is in a low content range of 0.5 parts by mass or more and 5 parts by mass or less. Thus, the volume expansion of the thermally conductive member itself is small. Furthermore, the thermally conductive member having a cross-linked structure exhibits high acid resistance after curing. Thus, even if gaseous acid is generated at a high temperature, deterioration of the thermally conductive member itself is limited. As a result, there is little risk of causing damage to the battery cell or the exterior due to a change in the shape of the thermally conductive member at a high temperature. After exposure to a high temperature, if the thermally conductive member is physically pressed against the substrate, the thermally conductive member can continuously exhibit its heat dissipation properties, although the properties would be diminished compared with when the adhesion caused by the hydrogen bond is intact.

### Advantageous Effects of Invention

The thermally conductive composition according to the present invention provides the thermally conductive member that exhibits good adhesion to the substrate before exposure to a high temperature and is easily peeled off from the substrate after exposure to a high temperature. Thus, the thermally conductive composition is useful for obtaining a gap filler or a heat dissipation sheet capable of reducing damage to a battery cell or its exterior caused by the gap filler firmly adhering to the battery cell or the exterior.

### DESCRIPTION OF EMBODIMENTS

Hereinafter, a thermally conductive composition, a method for producing the composition, and a method for producing a thermally conductive member using the composition according to the present invention will be described in detail. Herein, a thermally conductive filler is also simply referred to as a filler or filling material.

A thermally conductive composition according to the present invention contains:
a component (A) that is a diorganopolysiloxane having an alkenyl group bonded to a silicon atom;
a component (B) that is a diorganopolysiloxane having a hydrogen atom bonded to a silicon atom;
a component (C) that is expandable graphite;
a component (D) that is a thermally conductive filler; and
a component (E) that is an addition reaction catalyst, wherein
the content of the component (C) is 0.5 parts by mass or more and 5 parts by mass or less relative to 100 parts by mass of the total amount of the components (A) and (B), and
the content of the component (D) is 300 parts by mass or more and 2,000 parts by mass or less relative to 100 parts by mass of the total amount of the components (A) and (B).

When the expandable graphite of the component (C) is added to a composition containing the components (A), (B), (D), and (E), the composition can impart, to the thermally conductive member obtained after curing the composition, characteristics in that the cured product exhibits good adhesion to a substrate before exposure to a high temperature and is easily peeled off from the substrate after exposure to a high temperature.

The thermally conductive composition of the present invention may be any composition so long as the composition can form a thermally conductive member, and examples of the thermally conductive member include a heat dissipation sheet and a gap filler.

The thermally conductive composition of the present invention may be a thermally conductive gap filler composition that is used to obtain a gap filler by applying the composition in a liquid state before curing to a substrate and then curing the composition.

### Component (A):

The component (A), which is the main component of the thermally conductive composition, is a diorganopolysiloxane having an alkenyl group bonded to a silicon atom.

The component (A) may have a certain viscosity and a certain degree of polymerization which are not limited to particular values, and can be selected according to the required mixing viscosity of the thermally conductive composition. For example, the component (A) may have a viscosity, at 25° C., of 10 mPa·s or more and 1,000,000 mPa·s or less.

As the diorganopolysiloxane, one type thereof may be used alone, or two or more types thereof may be used in combination as appropriate. The diorganopolysiloxane is the main component of the thermally conductive composition and has at least one alkenyl group bonded to a silicon atom within one molecule on average, preferably 2 to 50 alkenyl groups, and more preferably 2 to 20 alkenyl groups.

The component (A) does not have a specifically limited molecular structure, and may have, for example, a linear structure, a partially branched linear structure, a branched chain structure, a cyclic structure, or a branched cyclic structure. Among these, the component (A) is preferably a substantially linear diorganopolysiloxane, and specifically, the component (A) may be a linear diorganopolysiloxane in which the molecular chain is mainly composed of a diorganosiloxane repeat unit and of which both terminals of the molecular chain are blocked with a triorganosiloxy group. Some or all of the molecular chain terminals, or some of the side chains, may be an Si—OH group.

The position of the alkenyl group bonded to the silicon atom in the component (A) is not particularly limited, and the component (A) may be a diorganopolysiloxane having an alkenyl group bonded to a silicon atom at both the molecular chain terminals. The diorganopolysiloxane having an alkenyl group bonded to both the molecular chain terminals is advantageous since the content of alkenyl groups, which serve as reaction sites for cross-linking reaction, is low, and flexibility of the gap filler obtained after curing is increased, so that the adhesion to the substrate can be further enhanced.

The alkenyl group may be bonded to the silicon atom at the molecular chain terminal, to the silicon atom at a non-terminal molecular chain site (in the middle of the molecular chain), or to both.

The component (A) may be a polymer composed of a single type of siloxane unit or a copolymer composed of two or more types of siloxane units.

The viscosity of the component (A) at 25° C. is 10 mPa·s or more and 1,000,000 mPa·s or less, preferably 20 mPa·s or more and 100,000 mPa·s or less, and more preferably 30 mPa·s or more and 2,000 mPa·s or less.

It is also possible to divide the components to be mixed into the thermally conductive composition into two or more liquid compositions, and store them. The liquid compositions can be mixed at the time of use to obtain the desired thermally conductive composition. In this case, the thermally conductive composition can be divided into a first liquid, which is a liquid composition containing the components (A), (C), (D), and (E), and a second liquid, which is a liquid composition containing the components (A), (B), (C), and (D). When the viscosity of the component (A) falls within the above-mentioned viscosity range, it is possible to suppress occurrence of a phenomenon in which the components (C) and (D) tend to precipitate in the obtained liquid composition due to too low viscosity of the component (A). Therefore, a thermally conductive composition exhibiting excellent long-term storage stability can be obtained. In addition, when the viscosity thereof falls within the above-mentioned viscosity range, since the obtained thermally conductive composition can exhibit appropriate fluidity, it is possible to improve the fluid ejection properties as well as the productivity.

In order to adjust the viscosity (mixing viscosity), before curing, of the thermally conductive composition that is obtained by mixing the liquid compositions, two or more types of diorganopolysiloxanes having an alkenyl group and having different viscosities can also be used in combination.

In order to achieve both long-term storage stability and appropriate fluidity, the component (A) preferably contains no diorganopolysiloxane having a viscosity, at 25° C., of 100,000 mPa·s or more, and more preferably contains no diorganopolysiloxane having a viscosity of 10,000 mPa·s or more.

The mixing viscosity of the thermally conductive composition refers to a value measured by a rotational viscometer before curing at a temperature of 25° C. and a shear rate of 10/s and may be in a range of 10 to 1,000 mPa·s, preferably in a range of 20 to 500 mPa·s, and more preferably in a range of 30 to 300 mPa·s. When the viscosity falls within the above-mentioned range, good workability is achieved when applying the thermally conductive composition to a substrate.

In order for the mixing viscosity to fall within the above-mentioned range, the viscosities at 25° C. of the components (A) and (B) may each be, for example, 10 mPa·s or more and 2,000 mPa·s or less.

The thermally conductive member obtained by curing the thermally conductive composition may be in any shape or any phase such as a sheet shape, a liquid phase, a block shape, or a cylinder shape, and is preferably in a sheet shape or a liquid phase.

When the thermally conductive member serves as a gap filler, the thermally conductive composition that is a liquid and has a mixing viscosity falling within the above-mentioned range can be extruded from a cartridge, a ribbon, or a container such as a dispenser, a syringe, or a tube, and applied to a substrate. When doing so, the workability is good. It is preferable to apply the composition to a substrate using a dispenser equipped with an L-shaped nozzle/needle or the like.

Here, the substrate refers to a heat dissipation portion and a heat generating portion. The silicone composition may be configured in such a manner that a heat generating portion is disposed so that the silicone composition is sandwiched between the heat generating portion and a heat dissipating portion after the silicone composition is applied to the heat dissipating portion, that a heat dissipation portion is disposed so that the silicone composition is sandwiched between the heat dissipation portion and a heat generating portion after the silicone composition is applied to the heat generating portion, or that the silicone composition is injected into a gap created between a heat generating portion and a heat dissipation portion.

A heat dissipation sheet can also be obtained by curing the thermally conductive composition into a sheet having a thickness of 0.01 to 50 mm, preferably 0.1 mm to 5 mm. The sheet shape may include not only a single sheet, but also a layered product laminated on another member and a thin film formed by coating another member with the composition. A heat dissipation sheet, which is a sheet-shaped thermally conductive member, may be arranged on the surface of a battery cell by pasting it or the like.

Specifically, the component (A) is represented by the following general formula (1) as an average composition formula:

R¹ₐSiO_{(4-a)/2} (1)

(In the formula (1), R¹s are the same as or different from each other and each are an unsubstituted or substituted monovalent hydrocarbon group having 1 to 18 carbon atoms, a is 1.7 to 2.1, preferably 1.8 to 2.5, and more preferably 1.95 to 2.05.). This organopolysiloxane is substantially linear, but may be branched to the extent that the properties of the thermally conductive member after curing are not impaired.

In one embodiment, at least two or more of the monovalent hydrocarbon groups represented by the aforementioned R¹ are selected from alkenyl groups such as a vinyl group, an allyl group, a propenyl group, an isopropenyl group, a butenyl group, an isobutenyl group, a hexenyl group, and a cyclohexenyl group. Groups other than these groups are substituted or unsubstituted monovalent hydrocarbon groups having 1 to 18 carbon atoms. Specifically, the aforementioned R¹ is selected from the group consisting of an alkyl group such as a methyl group, an ethyl group, a propyl group, an isopropyl group, a butyl group, an isobutyl group, a tert-butyl group, a pentyl group, a neopentyl group, a hexyl group, a 2-ethylhexyl group, a heptyl group, an octyl group, a nonyl group, a decyl group, and a dodecyl group; a cycloalkyl group such as a cyclopentyl group, a cyclohexyl group, and a cycloheptyl group; an aryl group such as a phenyl group, a tolyl group, a xylyl group, a biphenyl group, and a naphthyl group; an aralkyl group such as a benzyl group, a phenylethyl group, a phenylpropyl group, and a methylbenzyl group; and a halogen-substituted or cyano-substituted alkyl group in which a part or all of hydrogen atoms in the above-described hydrocarbon groups have been substituted with a halogen atom, a cyano group, or the like, such as a chloromethyl group, a 2-bromoethyl group, a 3,3,3-trifluoropropyl group, a 3-chloropropyl group, and a cyanoethyl group.

R¹s to be selected preferably include a vinyl group as the two or more alkenyl groups required, and a methyl group, a phenyl group, or a 3,3,3-trifluoropropyl group as the other groups. In addition, it is preferable that 70 mol % or more of R¹s be a methyl group, in consideration of physical properties and economic efficiency of the cured product, and normally, it is preferable that 80 mol % or more of R¹s be a methyl group.

Specific examples of the molecular structure of the component (A) include a dimethylpolysiloxane with both molecular chain terminals blocked with a dimethylvinylsiloxy group, a dimethylsiloxane-methylphenylsiloxane copolymer with both molecular chain terminals blocked with a dimethylvinylsiloxy group, a dimethylsiloxane-methylvinylsiloxane copolymer with both molecular chain terminals blocked with a dimethylvinylsiloxy group, a dimethylsiloxane-methylvinylsiloxane-methylphyenylsiloxane copolymer with both molecular chain terminals blocked with a dimethylvinylsiloxy group, a dimethylsiloxane-methylvinylsiloxane copolymer with both molecular chain terminals blocked with a trimethylsiloxy group, an organopolysiloxane composed of a siloxane unit represented by the formula: (CH₃)₂ViSiO_{1/2}, a siloxane unit represented by the formula: (CH₃)₃SiO_{1/2}, and a siloxane unit represented by the formula: SiO_{4/2} (Vi in the formula represents a vinyl group), an organopolysiloxane in which part or all of the methyl groups in the above-mentioned organopolysiloxanes are substituted by an alkyl group such as an ethyl group or a propyl group, an aryl group such as a phenyl group or a tolyl group, and a halogenated alkyl group such as a 3,3,3-trifluoropropyl group, and mixtures of two or more of these organopolysiloxanes. From the viewpoint of enhancing elongation at the time of breakage of the cured product due to increased molecular chain length, a linear diorganopolysiloxane with a vinyl group at both molecular chain terminals is preferable.

These diorganopolysiloxanes may be commercially available or prepared by methods known to those skilled in the art.

The content of the diorganopolysiloxane of the component (A), relative to 100 parts by mass of the total amount of the components (A) and (B) in the thermally conductive composition of the present invention, is preferably 2 parts by mass or more and 90 parts by mass or less, and more preferably 10 parts by mass or more and 80 parts by mass or less. When the content thereof falls within the aforementioned range, the viscosity of the entire thermally conductive composition can fall within an appropriate range, and the thermally conductive composition can exhibit excellent long-term storage stability, can suppress the phenomenon of flowing out after application to a substrate, and can maintain high thermal conductivity due to appropriate fluidity.

### Component (B):

The component (B) is a diorganopolysiloxane having a hydrogen atom bonded to a silicon atom.

The component (B) may have a viscosity and a degree of polymerization which are not limited to particular values and which can be selected according to the required mixing viscosity of the thermally conductive composition. For example, the component (B) may have a viscosity, at 25° C., of 10 mPa·s or more and 1,000,000 mPa·s or less.

The component (B) is a diorganopolysiloxane having one or more hydrogen atoms bonded to silicon atoms in one molecule, and acts as a cross-linking agent for curing the thermally conductive composition of the present invention.

The number of hydrogen atoms bonded to silicon atoms is not particularly limited as long as it is one or more, and may be two or more and four or less. The component (B) that is linear may have a hydrogen atom bonded to a silicon atom at each of both terminals, that is, may have two hydrogen atoms bonded to silicon atoms in the molecule.

The component (B) may be any diorganopolysiloxane as long as it contains one or more hydrogen atoms (SiH groups) bonded to silicon atoms within one molecule. Examples thereof that can be used include a dimethylsiloxane-methylhydrogensiloxane copolymer, a methylphenylsiloxane-methylhydrogensiloxane copolymer, and a copolymer composed of a dimethylhydrogensiloxy unit and an SiO_{4/2} unit. As the component (B), one type thereof may be used alone, or two or more types thereof may be used in combination as appropriate.

The molecular structure of the component (B) is not particularly limited, and may be, for example, a linear, branched, cyclic, or three-dimensional network structure. Specifically, the structure represented by the following average composition formula (2) can be used:

R³ₚH_{q}SiO_{(4-p-q)/2} (2)

(In the formula, R³ is an unsubstituted or substituted monovalent hydrocarbon group excluding an aliphatic unsaturated hydrocarbon group, p is 0 to 3.0, preferably 0.7 to 2.1, q is 0.0001 to 3.0, preferably 0.001 to 1.0, and p+q is a positive number satisfying 0.5 to 3.0, preferably 0.8 to 3.0.).

Examples of R³ in the formula (2) include non-substituted or halogen-substituted monovalent hydrocarbon groups and the like having 1 to 10 carbon atoms, preferably 1 to 8 carbon atoms excluding an aliphatic unsaturated hydrocarbon group. Specific examples thereof include an alkyl group such as a methyl group, an ethyl group, a propyl group, a butyl group, a pentyl group, a hexyl group, an isopropyl group, an isobutyl group, a tert-butyl group, and a cyclohexyl group; an aryl group such as a phenyl group, a tolyl group, and a xylyl group; an aralkyl group such as a benzyl group and a phenethyl group; and an alkyl halide group such as a 3-chloropropyl group and a 3,3,3-trifluoropropyl group. Among these, a methyl group, an ethyl group, a propyl group, a phenyl group, and a 3,3,3-trifluoropropyl group are preferable, and a methyl group is particularly preferable.

Specific examples of the component (B) include 1,1,3,3-tetramethyldisiloxane, 1,3,5,7-tetramethylcyclotetrasiloxane, a methylhydrogencyclopolysiloxane, a methylhydrogensiloxane-dimethylsiloxane cyclic copolymer, tris(dimethylhydrogensiloxy)methylsilane, tris(dimethylhydrogensiloxy)phenylsilane, a dimethylsiloxane-methylhydrogensiloxane copolymer with both molecular chain terminals blocked with a dimethylhydrogensiloxy group, a methylhydrogenpolysiloxane with both molecular chain terminals blocked with a dimethylhydrogensiloxy group, a methylhydrogenpolysiloxane with both molecular chain terminals blocked with a trimethylsiloxy group, a dimethylpolysiloxane with both molecular chain terminals blocked with a dimethylhydrogensiloxy group, a dimethylsiloxane-diphenylsiloxane copolymer with both molecular chain terminals blocked with a dimethylhydrogensiloxy group, a dimethylsiloxane-methylhydrogensiloxane copolymer with both molecular chain terminals blocked with a trimethylsiloxy group, a dimethylsiloxane-diphenylsiloxane-methylhydrogensiloxane copolymer with both molecular chain terminals blocked with a trimethylsiloxy group, a dimethylsiloxane-methylhydrogensiloxane copolymer with both molecular chain terminals blocked with a dimethylhydrogensiloxy group, a copolymer of a H(CH₃)₂SiO_{1/2} unit and an SiO₂ unit, a copolymer of a H(CH₃)₂SiO_{1/2} unit, a (CH₃)₃SiO_{1/2} unit, and an SiO₂ unit, and mixtures of two or more of these diorganopolysiloxanes.

In the composition described above, the content of the component (B) is preferably in such a range that the ratio of the number of SiH groups in the component (B) to that of the alkenyl group in the component (A) falls within the range of 1/5 to 7, more preferably within the range of 1/2 to 2, and still more preferably within the range of 3/4 to 5/4. When the content of the component (B) falls within the aforementioned range, the thermally conductive composition is sufficiently cured and the hardness of the entire thermally conductive composition becomes a more preferable range, so that cracks are less likely to occur when a thermally conductive member, which is obtained by curing the thermally conductive composition, is used as a gap filler or a heat dissipation sheet. In addition to these, when the thermally conductive member is used as a gap filler, there is an advantage that the thermally conductive composition dose not sag and can maintain its retention ability in the vertical direction even when the substrate is disposed in a vertical orientation (erected).

The SiH group in the component (B) may be bonded to the molecular chain terminals, may be bonded to side chains, or may be bonded to both the molecular chain terminals and the side chains. It is preferable to use a mixture of a diorganopolysiloxane having an SiH group only at the molecular chain terminals and a diorganopolysiloxane having an SiH group only on the side chain of the molecular chain.

The component (B) may be a diorganopolysiloxane having hydrogen atoms bonded only to silicon atoms at both terminals of the molecular chain. A diorganopolysiloxane having an SiH group at each terminal of the molecular chain has a low SiH group content, which can increase flexibility of the thermally conductive member obtained after curing and further can enhance adhesion to the substrate, which is advantageous.

The diorganopolysiloxane having an SiH group only at the molecular chain terminals has an advantage that the diorganopolysiloxane has high reactivity due to low steric hindrance, and the diorganopolysiloxane having an SiH group at the side chains contributes to network construction by a crosslinking reaction and thus has an advantage of improving the strength of the thermally conductive member. In order to impart flexibility to the thermally conductive member after curing, a diorganopolysiloxane having an SiH group only at the molecular chain terminals is preferably used.

From the viewpoint of improving adhesive properties and heat resistance, the component (B) may include an organohydrogenpolysiloxane having a trimethylsiloxy group at both the molecular chain terminals and at least one aromatic group contained within the molecule. For economic reasons, the aromatic group is more preferably a phenyl group.

The viscosity of the diorganopolysiloxane of the component (B) at 25° C. is 10 mPa·s or more and 1,000,000 mPa·s or less, preferably 20 mPa·s or more and 100,000 mPa·s or less, and more preferably 30 mPa·s or more and 2,000 mPa·s or less.

In order to adjust the viscosity of the thermally conductive composition, which is a final product, it is also possible to use two or more types of diorganopolysiloxanes having a hydrogen atom and having respective different viscosities. The mixing viscosity of the thermally conductive composition may be in the range of 10 to 1,000 mPa·s, more preferably in the range of 20 to 500 mPa·s, and even more preferably in the range of 30 to 250 mPa·s.

The content of the diorganopolysiloxane of the component (B), relative to 100 parts by mass of the total amount of the components (A) and (B) in the thermally conductive composition of the present invention, is preferably 10 parts by mass or more and 98 parts by mass or less, and more preferably 20 parts by mass or more and 90 parts by mass or less. When the content falls within the aforementioned range, the hardness of the cured thermally conductive composition can fall within an appropriate range. In addition, the thermally conductive member after curing can exhibit flexibility and robustness.

### Component (C):

The expandable graphite as the component (C) is added to facilitate peeling the thermally conductive member off from the substrate when the thermally conductive member is exposed to a high temperature.

The expandable graphite of the component (C) is not particularly limited, and known expandable graphite can be used as appropriate. The expandable graphite described herein may be any graphite that expands by heating, and a material in which a compound or the like is intercalated between layers of graphite (e.g., natural flake graphite, pyrolytic graphite, kish graphite, etc.) can be suitably used. Examples of such a compound that is intercalated between the graphite layers include an acid such as sulfuric acid and nitric acid, a mixture of these acids, a nitrate, potassium dichromate, potassium chlorate, potassium permanganate, ammonium peroxodisulfate, sodium peroxodisulfate, hydrogen peroxide, and potassium permanganate. As such an expandable graphite, a commercially available product can be appropriately used. Examples of the commercially available product that can be used include EXP-50 series and EXP-80 series manufactured by Fujikokuen Co., Ltd.; 953240 series, 9550 series, and 9510 series manufactured by Ito Graphite Co., Ltd.; 5099SS-3 and 60CA-60 manufactured by Cole Chemical & Distributing, Inc.; and SMF, EMF, SFF, and SS manufactured by Chuetsu Graphite Works Co., Ltd.

The expansion start temperature at which the expandable graphite of the component (C) expands is, in general, preferably 100 to 300° C., more preferably 150 to 300° C. The expansion start temperature can be controlled depending on the type of the compound that is intercalated between the layers and the like. When the expansion start temperature falls within the above-mentioned range, the expandable graphite starts to expand when extreme heat generation occurs in the battery, and the thermally conductive member is quickly peeled off from the substrate, making it possible to reduce damage or deformation of the battery cell or the exterior. Furthermore, even if the temperature of the battery increases to a certain level, the expandable graphite does not start to expand when extreme heat generation does not occur (e.g., in a case of less than 100° C.). This property makes it possible to prevent a phenomenon in which the thermally conductive member peels off from the substrate during normal heat generation and reduces the heat dissipation properties.

The expandable graphite of the component (C) expands while generating a gaseous inorganic acid at a temperature of 100° C. or higher and 300° C. or lower. The inorganic acid may be one or more selected from the group consisting of sulfuric acid, nitric acid, and hydrochloric acid.

The expandable graphite of the component (C) has an expansion ratio of preferably 100 to 300 cc/g, more preferably 150 to 250 cc/g. The expansion rate (volume after high temperature exposure/volume before high temperature exposure) of the thermally conductive member obtained by curing the thermally conductive composition including the expandable graphite in the above-mentioned added amount range may be 1.1 or less. When the expansion ratio of the expandable graphite falls within the above-mentioned range, the thermally conductive member exhibits a relatively small volume expansion while maintaining the property of being easily peeled off from the substrate after high temperature exposure. Therefore, it is possible to reduce damage to the battery cell caused by the volume expansion of the thermally conductive member. Furthermore, although the heat dissipation properties are impaired due to a reduction in the adhesion after the thermally conductive member is peeled off, the thermally conductive member itself has less heat insulation properties compared with one having a larger expansion ratio. This effect allows the thermally conductive member to maintain its heat dissipation properties to some extent by being physically pressed against the substrate.

The added amount of the expandable graphite (C) is in a range of 0.5 parts by mass or more and 5 parts by mass or less relative to 100 parts by mass of the total amount of the component (A) and the component (B). The added amount is more preferably 0.5 parts by mass or more and 3 parts by mass or less, still more preferably 0.5 parts by mass or more and 2 parts by mass or less. When the added amount falls within the above-mentioned range, the mixing viscosity of the thermally conductive composition can be kept low. In particular, in a case where the thermally conductive member is a gap filler, the thermally conductive composition is advantageous in that is can be injected into a fine gap and exhibit excellent crushing property. Furthermore, this allows the thermal conductive member to maintain low hardness after curing and exhibit excellent displacement followability when exposed to a high temperature. Furthermore, the expansion rate (volume after high temperature exposure/volume before high temperature exposure) of the thermally conductive member after exposed to a high temperature can be reduced to 1.1 or less.

It is preferable to reduce the added amount of the expandable graphite because the expansion rate of the thermally conductive member after exposed to a high temperature can be further reduced, and damage to a substrate or the like can be reduced.

It is more preferable that the added amount of the expandable graphite is further reduced to, for example, 2 parts by mass or less relative to 100 parts by mass of the total amount of the components (A) and (B) because the mixing viscosity can be further reduced to, for example, 95 mPa·s or less at 25° C.

Furthermore, although the expandable graphite has a defined volume resistivity, limiting the added amount to within the above-mentioned range makes it possible to obtain a thermally conductive member with high insulation properties.

Note that the volume resistivity of the thermally conductive composition is not particularly limited and can be selected as appropriate according to the application or shape of the thermally conductive member. High insulation properties are preferable in a case where a gap filler or a heat dissipation sheet is used in an electronic member. Thus, for example, the thermally conductive composition preferably has a volume resistivity of 1×10⁶ Ω·cm or more before curing.

### Component (D):

The thermally conductive filler of the component (D) is a filling material component that improves the thermal conductivity of the thermally conductive composition and the shape retentivity. As the component (D), a thermally conductive filler containing at least one selected from the group consisting of a metal, an oxide, a hydroxide, and a nitride can be used.

In order to obtain a thermally conductive member having high insulation properties for application to an electronic substrate or the like, it is preferable to use an inorganic material having excellent insulation properties as well as thermal conductivity as the thermally conductive filler of the component (D).

The shape of the component (D) is not particularly limited, and may be spherical, amorphous, or fibrous.

Examples of the thermally conductive fillers include a metal oxide such as aluminum oxide, zinc oxide, magnesium oxide, titanium oxide, silicon oxide, and beryllium oxide; a metal hydroxide such as aluminum hydroxide and magnesium hydroxide; a nitride such as aluminum nitride, silicon nitride, and boron nitride; a carbide such as boron carbide, titanium carbide, and silicon carbide; graphite; a metal such as aluminum, copper, nickel, and silver; and mixtures thereof.

In particular, when electrical insulation properties are required for the thermally conductive member, the component (D) is preferably selected from non-electroconductive thermally conductive fillers.

In this case, the component (D) may preferably be a metal oxide, a metal hydroxide, a nitride, or a mixture thereof, and may be an amphoteric hydroxide or an amphoteric oxide in some cases. Specifically, it is preferable to use one or more types selected from the group consisting of aluminum hydroxide, boron nitride, aluminum nitride, zinc oxide, aluminum oxide, magnesium oxide, and magnesium hydroxide. Among these, the component (D) preferably contains at least one selected from aluminum hydroxide and aluminum oxide.

It should be noted that aluminum oxide is an insulating material, has relatively good compatibility with the components (A) and (B), can be industrially selected from a wide variety of particle diameters, is a readily available resource, is relatively inexpensive, and is therefore suitable as the thermally conductive inorganic filling material.

When aluminum oxide is used as the component (D), aluminum oxide with a spherical shape or an amorphous shape is preferably used. Spherical aluminum oxide is α-alumina obtained mainly by high temperature thermal spraying or hydrothermal treatment of alumina hydrate. Herein, the spherical shape may be not only a true spherical shape but also a rounded shape.

The average particle diameter of the component (D) is not particularly limited, and may be in the range of, for example, 0.1 μm or more and 500 μm or less, preferably 0.5 μm or more and 200 μm or less, and more preferably 1.0 μm or more and 100 μm or less. If the average particle diameter is too small, the fluidity of the thermally conductive composition is lowered. If the average particle diameter is too large, dispensing properties are reduced, and there is a possibility that problems such as scraping of a coating apparatus are caused by catching the filler in the sliding portion of the coating apparatus. In the present invention, the average particle diameter of the component (D) is defined by D50 (or median diameter) which is a 50% particle diameter in the volume-based cumulative particle size distribution measured by a laser diffraction particle size measuring apparatus.

As the component (D), only a spherical filler or only an amorphous filler may be used, or the spherical filler and the amorphous filler may be used in combination. When at least two or more types of fillers having different shapes are used in combination, the composition can be filled with the fillers in a state close to close packing, so that thermal conductivity is advantageously further increased. When the proportion of a thermally conductive spherical filler is 30% by mass or more relative to 100% by mass of the whole component (D) in a case of using the thermally conductive spherical filler in combination with a thermally conductive amorphous filler, thermal conductivity can be further increased.

The BET specific surface area of the component (D) is not particularly limited. For example, the BET specific surface area of the spherical filler is preferably 1 m²/g or less, and more preferably 0.5 m²/g or less. The BET specific surface area of the amorphous filler is preferably 5 m²/g or less, and more preferably 3 m²/g or less.

When only the amorphous filler having a BET specific surface area of more than 5 m²/g is added, the viscosity of the thermally conductive composition is increased, and the adhesion of the thermally conductive composition to a substrate after curing is impaired. As a result, heat dissipation properties are impaired. When the composition is densely filled with a bulky filler, the motion of silicone rubber molecules in the composition is disturbed, and resiliency is impaired. In the present invention, the BET specific surface area of the component (D) is a value obtained by measuring the amount of gas physically adsorbed to the surface of particles in a low-temperature state and calculating a specific surface area.

In order to improve dispersibility and increase the filling properties of the filler, or to reduce the mixing viscosity, at least a part of the surface of the thermally conductive filler may be subjected to a surface treatment or coated. Any previously known surface treatment and coating may be suitable. When the thermally conductive member is applied to a resin substrate such as one made of PET, surface treatment or coating improves its adhesion, but tends to reduce the easiness of peeling-off from the substrate after high temperature exposure.

In the thermally conductive composition of the present invention, the content of the component (D), relative to 100 parts by mass of the total amount of the components (A) and (B), is preferably 300 parts by mass or more and 2,000 parts by mass or less, more preferably 400 parts by mass or more and 1,900 parts by mass or less, and even more preferably 500 parts by mass or more and 1,800 parts by mass or less.

When the content of the component (D) falls within the aforementioned range, the thermally conductive composition as a whole has sufficient thermal conductivity. In addition, mixing of the component (D) can be facilitated, flexibility even after curing can be maintained, and the specific gravity of the cured product does not become too large. Thus, the thermally conductive composition is more suitably used for forming a thermally conductive member for which thermal conductivity and weight reduction are required. If the content of the component (D) is too small, difficulties occur in sufficiently increasing the thermal conductivity of the resulting cured product of the thermally conductive composition. If the content of the component (D) is too large, the thermally conductive composition becomes highly viscous, which may make uniform application of the thermally conductive composition difficult, resulting in problems in that thermal resistance of the cured product of the composition increases and flexibility thereof deteriorates.

### Component (E):

The addition reaction catalyst of the component (E) is a catalyst that promotes an addition-curing reaction between an alkenyl group bonded to a silicon atom in the component (A) described above and a hydrogen atom bonded to a silicon atom in the component (B) described above, and is a catalyst known to those skilled in the art. Examples of the component (E) include a platinum group metal such as platinum, rhodium, palladium, osmium, iridium, and ruthenium, and catalysts in which any of the aforementioned metals is supported by a particulate carrying material (for example, activated carbon, aluminum oxide, and silicon oxide).

Furthermore, examples of the component (E) include a platinum halide, a platinum-olefin complex, a platinum-alcohol complex, a platinum-alcoholate complex, a platinum-vinylsiloxane complex, dicyclopentadiene-platinum dichloride, cyclooctadiene-platinum dichloride, and cyclopentadiene-platinum dichloride.

In addition, from an economic viewpoint, a metal compound catalyst other than platinum group metals as described above may be used. Examples of the iron catalyst for hydrosilylation include an iron-carbonyl complex catalyst, an iron catalyst having a cyclopentadienyl group as a ligand, an iron catalyst having a terpyridine-based ligand or a combination of a terpyridine-based ligand and a bistrimethylsilylmethyl group, an iron catalyst having a bisiminopyridine ligand, an iron catalyst having a bisiminoquinoline ligand, an iron catalyst having an aryl group as a ligand, an iron catalyst having a cyclic or acyclic olefin group with an unsaturated group, and an iron catalyst having a cyclic or acyclic olefinyl group with an unsaturated group. Other examples of the catalyst for hydrosilylation include a cobalt catalyst, a vanadium catalyst, a ruthenium catalyst, an iridium catalyst, a samarium catalyst, a nickel catalyst, and a manganese catalyst.

The added amount of the component (E) as the concentration of the catalyst metal element is in the range of preferably 0.5 to 1,000 ppm, more preferably 1 to 500 ppm, and still more preferably 1 to 100 ppm relative to the total mass of the thermally conductive composition, although an effective amount thereof according to the curing temperature and curing time desired depending on the use applications is used. If the added amount is less than 0.5 ppm, the addition reaction becomes remarkably slow. If the added amount exceeds 1,000 ppm, the cost increases, which is not economically preferable.

In the thermally conductive composition described above, the components (A) and (B) undergo a crosslinking reaction in the presence of the addition reaction catalyst (E) to give a cured product (gap filler). The thermally conductive composition necessarily has a thermal conductivity of 1 or more, and may preferably be 2 or more. The specific gravity of the composition should be 1.5 or more and 10 or less. Since having reduced weight tends to be important for a substrate to which the thermally conductive composition is applied or a member including a substrate in which the thermally conductive member is used (e.g., an electronic device, a battery, or the like), the specific gravity of the composition is preferably 5.0 or less, and more preferably 3.0 or less.

As a method for producing the thermally conductive composition according to the present invention, any method known to a person skilled in the art can be used without any limitation. For example, the method may include steps of mixing the components (A), (B), and (D), adding the component (C) to the mixture, and mixing the mixture.

An exemplary method for producing the composition includes mixing the components (A), (B) and (D) in advance with a stirrer, or uniformly kneading these components with a high-shear mixer or extruder such as a two-roll mill, a kneader, a pressure kneader, a Ross mixer, a continuous extruder, or the like, to prepare a silicone rubber base, and then adding the component (C) thereto.

In the thermally conductive composition of the present invention, as an additional optional component other than the aforementioned components (A) to (E), a conventionally known additive for use in a silicone rubber or gel can be used as long as the object of the present invention is not impaired. Examples of such additives include an organosilicon compound or an organosiloxane (also referred to as a silane coupling agent) that produces silanols by hydrolysis, a cross-linking agent, a condensation catalyst, an adhesive aid, a pigment, a dye, a curing inhibitor, a heat-resistance imparting agent, a flame retardant, an antistatic agent, a conductivity imparting agent, an airtightness improving agent, a radiation shielding agent, an electromagnetic wave shielding agent, a preservative, a stabilizer, an organic solvent, a plasticizer, a fungicide, an organopolysiloxane which contains one hydrogen atom or alkenyl group bonded to a silicon atom within one molecule and which contains no other functional groups, and a non-functional organopolysiloxane containing neither a hydrogen atom nor an alkenyl group bonded to a silicon atom. As these optional components, one type thereof may be used alone, or two or more types thereof may be used in combination as appropriate.

Examples of the silane coupling agent include an organosilicon compound and an organosiloxane, having an organic group such as an epoxy group, an alkyl group, or an aryl group and a silicon atom-bonded alkoxy group within one molecule. An example of the silane coupling agent is a silane compound such as octyltrimethoxysilane, octyltriethoxysilane, decyltrimethoxysilane, decyltriethoxysilane, dodecyltrimethoxysilane, or dodecyltriethoxysilane. The silane compound may be a compound having no SiH group. One type thereof may be used alone, or two or more types thereof may be used in combination as appropriate. When the surface of the thermally conductive filler is treated with the silane coupling agent, the affinity with the silicone polymer can be improved, the viscosity of the composition can be decreased, and the filling properties of the filler can be improved. Therefore, when a larger amount of filler is added, thermal conductivity can be improved.

A silanol produced by hydrolysis can react with and bond with a condensable group (for example, a hydroxyl group, an alkoxy group, an acid group, or the like) present on the surface of a metal substrate or an organic resin substrate. The silanol and the condensable group undergo a reaction with and are bonded to each other by the catalytic effect of the condensation catalyst described later, thereby progressing the adhesion of the thermally conductive member to various substrates.

As the amount of the silane coupling agent added relative to that of the filler, an effective amount according to curing temperature or curing time desired depending on the use applications is used. A general optimum amount is usually 0.5 to 2 wt % relative to the amount of the thermally conductive filler. A standard of a required amount is calculated by the following expression. The silane-coupling agent may be added in an amount one to three times the standard of the required amount.

Required amount (g) of silane coupling agent=Weight (g) of filler×Specific surface area (m²/g)/minimal covering area specific to silane coupling agent (m²/g)

The cross-linking agent is an organohydrogenpolysiloxane that can undergo an addition reaction with an alkenyl group to form a cured product and can have at least three or more SiH groups within one molecule. The cross-linking agent in the present invention is preferably an organohydrogenpolysiloxane having five or more SiH groups. The cross-linking agent may be an organohydrogenpolysiloxane having 10 or more and 15 or less SiH groups. The organohydrogenpolysiloxane that is the cross-linking agent has at least one SiH group bonded to its side chain. The number of SiH groups at a molecular chain terminal may be zero or more and two or less, and preferably two in terms of cost. The molecular structure of the organohydrogenpolysiloxane may be any of linear, cyclic, branched, and three-dimensional network structures. The position of the silicon atom to which a hydrogen atom is bonded is not particularly limited. Such a silicon atom may be at a molecular chain terminal, at a non-terminal molecular chain site (in the middle of the molecular chain), or at a side chain. Other conditions, the type of the organic group, the bonding position thereof, the degree of polymerization, structure, and the like in the organohydrogenpolysiloxane serving as the cross-linking agent are not particularly limited. Two or more types of organohydrogenpolysiloxanes may be used.

As necessary, a condensation catalyst may be used together with the silane coupling agent described above. As the condensation catalyst, a compound of a metal selected from magnesium, aluminum, titanium, chromium, iron, cobalt, nickel, copper, zinc, zirconium, tungsten, and bismuth can be used. Preferable examples of the condensation catalysts include metal compounds such as organic acid salts, alkoxides, and chelate compounds, of trivalent aluminum, trivalent iron, trivalent cobalt, divalent zinc, tetravalent zirconium, and trivalent bismuth. Specific examples thereof include an organic acid such as octylic acid, lauric acid, and stearic acid, an alkoxide such as a propoxide and a butoxide, and a multidentate ligand chelating compound such as catechol, crown ether, a polyvalent carboxylic acid, hydroxy acid, diketone, and keto acid. Here, a plurality of types of ligands may be bonded to one metal. In particular, a compound of zirconium, aluminum, or iron, which is likely to give stable curability even when the chemical composition and use conditions are somewhat different, is preferred. In addition, examples of the more desirable compounds include a butoxide of zirconium and a trivalent chelate compound of aluminum or iron including multidentate ligands such as a malonic acid ester, an acetoacetic acid ester, an acetylacetone, or a substituted derivative thereof. In the case of a trivalent aluminum or iron metal compound, an organic acid having 5 to 20 carbon atoms, such as octylic acid, may be preferably used. The polydentate ligand and the organic acid may be bonded to one metal, and the resulting structure may also be adopted.

Examples of the aforementioned substituted derivative include those in which a hydrogen atom contained in the compound described above is substituted with an alkyl group such as a methyl group or an ethyl group, an alkenyl group such as a vinyl group or an allyl group, an aryl group such as a phenyl group, a halogen atom such as a chlorine atom or a fluorine atom, a hydroxyl group, a fluoroalkyl group, an ester group-containing group, an ether-containing group, a ketone-containing group, an amino group-containing group, an amide group-containing group, a carboxylic acid-containing group, a nitrile group-containing group, an epoxy group-containing group, or the like. Specific examples thereof include 2,2,6,6-tetramethyl-3,5-heptanedione and hexafluoropentanedione.

As the adhesive aid, one having an alkoxy group in the molecule is preferable, and specifically, tetraethoxysilane is preferable. Other preferred examples thereof include 3-glycidoxypropyltrimethoxysilane, 3-glycidoxypropyltriethoxysilane, an oligomer of 3-glycidoxypropyltrimethoxysilane, an oligomer of 3-glycidoxypropyltriethoxysilane, and those having as an organofunctional group, one or more groups selected from a vinyl group, a methacryl group, an acryl group, and an isocyanate group. Further examples thereof include a methacryloxysilane such as 3-methacryloxypropyltrimethoxysilane and 3-methacryloxypropyltriethoxysilane, 3-trimethoxysilylpropylsuccinic anhydride, and a furandione such as dihydro-3-(3-(triethoxysilyl)propyl)-2,5-furandione.

The organic functional group may be bonded to a silicon atom via another group such as an alkylene group. In addition to the above, those containing an organosilicon compound or an organosiloxane having an organic group such as an epoxy group, an alkyl group, or an aryl group and a silicon atom-bonded alkoxy group within one molecule are preferred. Furthermore, an organosilicon compound or an organosiloxane having at least one organic group such as an epoxy group, an alkyl group, or an aryl group and at least two silicon atom-bonded alkoxy groups within one molecule are preferred. Such epoxy groups can be bonded to a silicone atom in the form of a glycidoxyalkyl group such as a glycidoxypropyl group, or an epoxy-containing cyclohexylalkyl group such as a 2,3-epoxycyclohexylethyl group or a 3,4-epoxycyclohexylethyl group. Alternatively, an organic group having a linear or branched alkyl group having 1 to 20 carbon atoms or an aromatic ring is preferred. If the epoxy group is contained, two to three epoxy groups may be contained within one molecule. Preferred examples of the silicon atom-bonded alkoxy group include a methoxy group, an ethoxy group, a propoxy group, and an alkyldialkoxysilyl group such as a methyldimethoxysilyl group, an ethyldimethoxysilyl group, a methyldiethoxysilyl group, and an ethyldiethoxysilyl group.

As functional groups other than those described above, for example, a functional group selected from an alkenyl group such as a vinyl group, a (meth)acryloxy group, a hydrosilyl group (an SiH group), and an isocyanate group may be used.

Examples of the pigment include titanium oxide, alumina silicic acid, iron oxide, zinc oxide, calcium carbonate, carbon black, a rare earth oxide, chromium oxide, a cobalt pigment, ultramarine blue, cerium silanolate, aluminum oxide, aluminum hydroxide, titanium yellow, barium sulfate, precipitated barium sulfate, and mixtures thereof.

The added amount of the pigment is preferably in the range of 0.001% to 5% relative to the total mass of the thermally conductive composition although an effective amount thereof according to the curing temperature and curing time desired depending on the use applications is used. The amount of the pigment is preferably in the range of 0.01% to 2%, and more preferably 0.05% to 1%. If the added amount is less than 0.001%, the resulting composition is insufficiently colored, so it is difficult to visually distinguish the first liquid from the second liquid. On the other hand, if the added amount exceeds 5%, the cost will increase, which is not economically preferable.

The curing inhibitor has an ability of adjusting the curing rate of the addition reaction, and any curing inhibitor conventionally known in the art can be used as the compound having a curing suppressing effect. Examples thereof include an acetylene-based compound, hydrazines, triazoles, phosphines, and mercaptans. Specific examples of such compounds include a phosphorus-containing compound such as triphenylphosphine, a nitrogen-containing compound such as tributylamine, tetramethylethylenediamine, and benzotriazole, a sulfur-containing compound, an acetylene-based compound, a compound containing two or more alkenyl groups, a hydroperoxy compound, a maleic acid derivative, and silane and a silicone compound having an amino group.

The added amount of the curing inhibitor is preferably in the range of 0.1 parts by mass to 15 parts by mass relative to 100 parts by mass of the total amount of the components (A) and (B), although an effective amount thereof depending on the curing temperature and curing time desired depending on the use applications is used. The added amount is preferably in the range of 0.2 parts by mass to 10 parts by mass, and more preferably in the range of 0.5 parts by mass to 5 parts by mass. If the amount is less than 0.1 parts by mass, the addition reaction becomes remarkably accelerated, and the curing reaction proceeds during coating, which may deteriorate the workability. On the other hand, if the amount exceeds 10 parts by mass, the addition reaction becomes slow, so a pump-out phenomenon may occur.

Specific examples of the curing inhibitors include various “ene-yne” systems such as 3-methyl-3-pentene-1-yne and 3,5-dimethyl-3-hexene-1-yne; an acetylenic alcohol such as 3,5-dimethyl-1-hexin-3-ol, 1-ethynyl-1-cyclohexanol, and 2-phenyl-3-butyn-2-ol; well-known maleates and fumarates such as a dialkyl maleate, a dialkenyl maleate, a dialkoxyalkyl maleate, a dialkyl fumarate, a dialkenyl fumarate, and a dialkoxyalkyl fumarate; and those containing cyclovinylsiloxane.

Examples of the heat-resistance imparting agent include cerium hydroxide, cerium oxide, iron oxide, fumed titanium dioxide, and mixtures thereof.

As the airtightness improving agent, any agent may be used as long as it has an effect of reducing the air permeability of the cured product, and any organic or inorganic substance may be used. Specific examples thereof include a urethane, a polyvinyl alcohol, a polyisobutylene, an isobutylene-isoprene copolymer, talc having a plate-like shape, mica, glass flakes, boehmite, powders of various metal foils and metal oxides, and mixtures thereof.

The thermally conductive composition according to the present invention may not contain an organosilicon compound having one or more alkenyl groups and one or more alkoxy groups bonded to silicon atoms within one molecule. When a compound having an alkenyl group and an alkoxy group bonded to a silicon atom within one molecule is contained in the composition, the compound acts as a component for bonding the substrate to the gap filler. The composition according to the present invention that does not contain such a component can further reduce deformation, damage, or the like of batteries etc., when a thermally conductive member is exposed to a high temperatures to be peeled off from a substrate.

The present invention further provides a thermally conductive composition including:
a component (A) that is a diorganopolysiloxane having an alkenyl group bonded to a silicon atom;
a component (B) that is a diorganopolysiloxane having a hydrogen atom bonded to a silicon atom;
a component (C) that is expandable graphite;
a component (D) that is a thermally conductive filler; and
a component (E) that is an addition reaction catalyst, in which a thermally conductive member obtained by curing the thermally conductive composition has a thermal conductivity of 1 W/m·K or more at −30° C. to 80° C. and is a gap filler that satisfies the following conditions (a) and (b):
(a) the shear adhesion strength (lap-shear strength) of the thermally conductive member before heating measured by the following test is 0.1 MPa or more, and
(b) the shear adhesion strength of the thermally conductive member after heating at 250° C. for 1 hour or longer measured by the following test is less than 0.1 MPa. Test: the thermally conductive composition is sandwiched between an aluminum plate and an electrodeposition-coated steel plate so as to have a coating thickness of 1 mm and is allowed to stand at room temperature for one day for curing. Then, a shear adhesion tensile test is performed at a tensile rate of 50 mm/min at room temperature (23° C.) using a tensile tester to measure the stress at break as the shear adhesion strength.

The term “before heating” described herein refers to a state in which the thermally conductive member, which has been formed by curing the thermally conductive composition, is not yet exposed to a high temperature of 80° C. or higher. The term “after heating” refers to a state in which the thermally conductive composition has been cured and then exposed to a high temperature of 250° C. or higher for 1 hour or longer.

As described above, before heating, the specific surface area of the expandable graphite is small, and the thermally conductive member exhibits a large cohesive force and high adhesion to a substrate. The appropriate shear adhesion strength varies depending on the characteristics, shape, and the like of the thermally conductive member. For example, in a case where the thermally conductive member is a gap filler, the shear adhesion strength measured by the above-mentioned test method is 0.10 MPa or more. The shear adhesion strength is more preferably 0.11 MPa or more, still more preferably 0.12 MPa or more.

In a case where the thermally conductive member is a heat dissipating sheet, the shear adhesion strength may be lower than that in the gap filler.

When the thermally conductive member is heated at 250° C. for 1 hour or longer, the cohesive force of the thermally conductive member decreases due to the effect of the expandable graphite, and the thermally conductive member tends to peel off from an adherend base material or a substrate for forming the heat dissipation sheet. Thus, the shear adhesion strength measured by the above-mentioned method is reduced to less than 0.1 MPa. The shear adhesion strength after heating is more preferably 0.09 MPa or less, still more preferably 0.08 MPa or less.

The thermally conductive composition according to the present invention is an addition-curable composition and may be a one-component composition or a two-component composition. The one-component composition can have an improved storage property when the composition is appropriately designed to be cured by heat.

In the case of a two-component composition, it becomes possible to further improve storage stability without these contrivances, and it is easy to obtain a composition that cures at room temperature (e.g., 25° C.). In this case, the thermally conductive composition according to the present invention can be dispensed into the first liquid and the second liquid, for example as follows. The first liquid does not contain the component (B) and contains the component (E), and the second liquid contains the component (B) and does not contain the component (E).

Therefore, the method for producing the two-component thermally conductive composition according to the present invention includes:
a first step of mixing the component (A) that is a diorganopolysiloxane having an alkenyl group bonded to a silicon atom, the component (C) that is expandable graphite, the component (D) that is a thermally conductive filler, and the component (E) that is an addition reaction catalyst to obtain a first liquid; and
a second step of mixing the component (A) that is a diorganopolysiloxane having an alkenyl group bonded to a silicon atom, the component (B) that is a diorganopolysiloxane having a hydrogen atom bonded to a silicon atom, the component (C) that is expandable graphite, and the component (D) that is a thermally conductive filler to obtain a second liquid.

The present invention also provides a method for producing a thermally conductive member, comprising a mixing step of mixing the first liquid and the second liquid of the two-component thermally conductive composition, an application step of applying the resulting mixture of the first liquid and the second liquid obtained in the mixing step to a base material or a substrate for forming a heat dissipation sheet, and a curing step of curing the uncured mixture applied in the application step.

The thermally conductive composition applied to the substrate in the application step forms a thermally conductive member that is a non-flowable cured product within about 120 minutes after application. The temperature for curing after application to the substrate is not particularly limited, and may be, for example, a temperature of 15° C. or higher and 60° C. or lower. In order to reduce thermal damage to the substrate and the like, the temperature may be 15° C. or higher and 40° C. or lower. When the composition is a heat-curable composition, the composition may be applied to a substrate or the like and then heated, or may be cured by utilizing heat radiated from a heat dissipation member. The temperature for heat curing may be, for example, 40° C. or higher and 200° C. or lower.

The substrate to which the gap filler or the heat dissipation sheet is applied is not particularly limited, and examples thereof include resins such as a polyethylene terephthalate (PET), a poly(1,4-butylene terephthalate) (PBT), and a polycarbonate, ceramics, glasses, and metals such as aluminum.

The thermally conductive member produced by the above-described method has good adhesion and adhesive properties to substrates, and has excellent heat dissipation characteristics. Furthermore, it is possible to reduce damage and deformation of the substrate when the adhesive properties to the substrate is impaired when exposed to an extremely high temperatures. In addition to this, when produced from a two-component thermally conductive composition with high storage stability, a high-quality thermally conductive member can be advantageously obtained even by using the thermally conductive composition after long-term storage.

The present invention also provides a method for controlling a shear adhesion strength of a cured product of the above-described thermally conductive composition, after heating at 250° C. for 1 hour, to a value equal to or less than 0.8 times a value before heating, the method including adding a component (C) that is expandable graphite to a mixture containing a component (A) that is a diorganopolysiloxane having an alkenyl group bonded to a silicon atom, a component (B) that is a diorganopolysiloxane having a hydrogen atom bonded to a silicon atom, a component (D) that is a thermally conductive filler, and a component (E) that is an addition reaction catalyst, wherein an added amount of the component (C) relative to 100 parts by mass of the total amount of the components (A) and (B) is 0.5 parts by mass or more and 5 parts by mass or less, and the shear adhesion strength is measured by the following test method:

Test: the thermally conductive composition is sandwiched between an aluminum plate and an electrodeposition-coated steel plate so as to have a coating thickness of 1 mm and is allowed to stand at room temperature for one day for curing; and then, a shear adhesion tensile test is performed at a tensile rate of 50 mm/min at room temperature using a tensile tester to measure the stress at break as the shear adhesion strength.

When the shear tensile adhesion after heating falls within the range with the above-mentioned magnification factor, the thermally conductive composition can exhibit the property of being easily peeled off from the substrate after high temperature exposure.

### EXAMPLES

The present invention will be specifically described on the basis of Examples, but the present invention is not limited to the following Examples. Table 1 shows mixing ratios of components in Examples and Comparative Examples, and evaluation results. Numerical values of the mixing ratios shown in Table 1 are expressed in part by mass.

### Method for Producing Thermally Conductive Composition and Cured Product Thereof (Thermally Conductive Member):

A first liquid and a second liquid described in each of Examples and Comparative Examples were weighed at a ratio of 1:1, sufficiently mixed by a stirrer, and then degassed by a vacuum pump, to produce each thermally conductive composition. The thermally conductive compositions were each cured to produce a specimen in accordance with each evaluation item. As a result, each cured product as a thermally conductive member was obtained.

### Method for Measuring Hardness:

The first liquid and the second liquid described in each of Examples and Comparative Examples were weighed at a ratio of 1:1, sufficiently mixed by a stirrer, and then degassed by a vacuum pump. The resultant thermally conductive composition was poured into a columnar press mold having a diameter of 30 mm and a height of 6 mm, and then cured at 100° C. for 60 minutes, to obtain each columnar cured product.

A Shore-00 hardness was measured in accordance with the Japanese Rubber Institute Standard JIS K6253 method using a durometer hardness tester in an environment of 23° C. Specifically, the durometer hardness tester was pressed, from directly above, against the top surface of the obtained columnar cured product, and the value obtained by bringing the pressure surface into close contact therewith was set as the measurement value. The Shore-00 hardness was measured three times using the hardness tester, and the average of the measurement results was used. In general, the lower the Shore-00 hardness is, the higher the flexibility is indicated to be.

It is preferable that the Shore-00 hardness of the cured product fall within the range of 50 or more and 95 or less. If the hardness is less than 50, the strength of the cured product is insufficient, and sufficient shear strength cannot be obtained. On the other hand, if the hardness exceeds 95, the flexibility of the cured product is impaired, and it is presumed that the cured product is not able to sufficiently follow the adherend's surface when vibration occurs between the heat generating body and the heat dissipation body after the composition is filled and cured in the gap.

### Method for Measuring Specific Gravity:

The first liquid and the second liquid described in each of Examples and Comparative Examples were weighed at a ratio of 1:1, sufficiently mixed by a stirrer, and then degassed by a vacuum pump. The resultant thermally conductive composition was poured into a sheet-shaped press mold having a length of about 10 cm, a width of about 10 cm, and a thickness of 2 mm, and then cured at 100° C. for 60 minutes, to obtain each cured product.

The specific gravity (density) (g/cm³) of the cured product obtained in each of Examples and Comparative Examples was measured in accordance with JIS K6249.

In a case of application in which weight reduction is important, the specific gravity is preferably 3.0 or less. Furthermore, it is possible to confirm that an expandable material expands after heating by exposing a similarly prepared test piece to a temperature of 250° C. for 1 hour and then measuring the specific gravity using the same method to determine if the specific gravity is lower than that before heating. The specific gravity of the test piece after heating is, as multiplied by the specific gravity of the test piece before heating, preferably 0.95 times or more and 0.99 times or less, more preferably 0.97 times or more and 0.99 times or less.

### Method for Measuring Thermal Conductivity:

The first liquid and the second liquid described in each of Examples and Comparative Examples were weighed at a ratio of 1:1, sufficiently mixed by a stirrer, and then degassed by a vacuum pump. The resultant thermally conductive silicone composition was poured into a columnar press mold having a diameter of 30 mm and a height of 6 mm, and then cured at 100° C. for 60 minutes, to obtain each columnar cured product. The thermal conductivity of the cured product was measured by a measurement device (TPS-500 manufactured by Kyoto Electronics Manufacturing Co., Ltd.) on the basis of a hot disc method in accordance with ISO 22007-2. A sensor was disposed between two columnar cured products that were produced as described above, and the thermal conductivity was measured by the measurement device.

The thermal conductivity is preferably 2.0 W/m·k or more.

### Method for Measuring Shear Adhesion Strength:

A shear tensile strength was measured in accordance with JIS K6850 to be regarded as the shear adhesion strength (lap-shear strength). Specifically, an aluminum plate having a length of about 60 cm, a width of about 25 cm, and a thickness of 2 mm and an electrodeposition-coated steel plate were used as substrates. A thermally conductive composition was applied to one of the plates as a first substrate with an area of about 25 mm in length and about 25 mm in width and a thickness of about 1 mm, and the applied composition was sandwiched between the first substrate and the other plate. The resulting product was cured at room temperature for 24 hours. After that, the plates as the first and second substrates were pulled at a rate of 50 mm/min in the shear direction, and the stress at the time point when the two substrates were peeled off was regarded as the shear adhesion strength. The stress as the shear adhesion strength was measured in an environment of 23° C. using an autograph manufactured by Shimadzu Corporation.

Before exposure to a high temperature, it is necessary for the thermally conductive composition to exhibit adhesion to a substrate, and so the shear adhesion strength is preferably 0.1 MPa or more. On the other hand, after preparing a test piece in the same manner and exposing it to a high temperature of 250° C. for 1 hour, it is necessary for the plates to be easily peeled off when the shear adhesion strength is measured. Therefore, the shear adhesion strength after high temperature exposure is preferably less than 0.1 MPa, and more preferably 0.08 MPa or less.

### Method for Measuring Mixing Viscosity:

The first liquid and the second liquid described in each of Examples and Comparative Examples were weighed at a ratio of 1:1, and sufficiently mixed by a stirrer, and the viscosity of the mixture was measured at 25° C. in accordance with JIS K7117-2. Specifically, the not yet cured thermally conductive composition was placed between parallel plates having a diameter of 25 mm, and the viscosity thereof was measured at a shear rate of 10 (1/s) and a gap of 0.5 mm by Physica MR 301 manufactured by Anton Paar.

It can be said that the coating workability is good if the viscosity is 500 Pa·s or less.

### Method for Measuring Volume Resistivity:

The volume resistivity of the thermally conductive composition of the present invention was measured by a method in accordance with IEC 60093. The volume resistivity is preferably 1×10⁶ Ω·cm or more, more preferably 1×10⁷ Ω·cm or more. When the volume resistivity falls within this range, the composition of the present invention can ensure the insulation properties.

### Method for Producing Cured Product of Thermally Conductive Composition:

### Example 1

The first liquid and the second liquid were each produced in accordance with the chemical composition shown in fields of Example 1 in Table by the following procedures. The unit of mixing ratio of each component shown in Table is part by mass.

### First Liquid for Examples 1 and 7

A diorganopolysiloxane having an alkenyl group as the component (A), a platinum-divinyltetramethyldisiloxane complex as the component (D), an n-octyltriethoxysilane as a silane coupling agent of an optional component, A-137 manufactured by Momentive Performance Materials Worldwide LLC, 3-methyl-3-pentene-1-yne as a curing inhibitor, tetranormalbutyl zirconate as a condensation catalyst, and Stan-Tone 50SP01 Green manufactured by Polyone Corp. as a pigment were each weighed, added together, and kneaded at room temperature for 30 minutes with a planetary mixer.

The component (A) is a linear dimethylpolysiloxane having alkenyl groups only at both terminals, with a viscosity of 150 mPa·s.

A half amount of spherical alumina having an average particle diameter of 45 μm and a half amount of amorphous alumina having an average particle diameter of 3 μm as the thermally conductive filler of the component (C) were added and kneaded for 15 minutes at room temperature with a planetary mixer.

After that, a half amount of the silane coupling agent, respective half amounts of the spherical thermally conductive filler and the amorphous thermally conductive filler as the component (C), and expandable graphite as the component (E) were added, and kneaded for 15 minutes at room temperature with a planetary mixer to prepare a first liquid.

Spherical alumina DAM-45 (average particle diameter of 45 μm) manufactured by Denka Co., Ltd. was used as the spherical alumina.

Fine-grained alumina AL-S43B (average particle diameter of 3 μm) manufactured by Sumitomo Chemical Co., Ltd. was used as the amorphous alumina. As the expandable graphite, EXP-50HO manufactured by Fujikokuen Co., Ltd. (expandable graphite, expansion ratio of 200 cc/g, expansion start 220° C.) was used. In Example 1 to Example 7, the added amount of the expandable graphite was varied from 0.5 parts by mass to 5 parts by mass.

### Second Liquid for Examples 1 and 7

A diorganopolysiloxane, having the same alkenyl group as that for the first liquid, as the component (A), a linear diorganopolysiloxane having a viscosity of 100 mPa·s with two hydrogen atoms at both terminals as the component (B), and a cross-linking agent, a silane coupling agent and an adhesive aid as optional components were each weighed, added together, and kneaded for 30 minutes at room temperature with a planetary mixer.

The cross-linking agent as the optional component is a dimethylpolysiloxane having hydrogen atoms bonded to the silicon atoms only at the side chains, with a viscosity of 200 mPa·s. The adhesive aid as the optional component is tetraethoxysilane.

Subsequently, a half amount of the silane coupling agent as the optional component, and respective half amounts of the spherical alumina having an average particle diameter of 45 μm and the amorphous alumina having an average particle diameter of 3 μm as the thermally conductive filler of the component (C) the same as those for the first liquid were added and kneaded for 15 minutes at room temperature with a planetary mixer.

After that, a half amount of the silane coupling agent, respective half amounts of the spherical thermally conductive filler and the amorphous thermally conductive filler as the component (C) the same as those for the first liquid, and expandable graphite as the component (E) were added, and kneaded for 15 minutes at room temperature with a planetary mixer to prepare a second liquid. In Example 1 to Example 7, the added amount of the expandable graphite was varied from 0.5 parts by mass to 5 parts by mass.

### Example 9

A first liquid and a second liquid were prepared in the same manner as that in Example 3 except that EXP-50S 160 manufactured by Fujikokuen Co., Ltd. (expandable graphite, expansion ratio of 300 cc/g, expansion start 160° C.) was used as the expandable graphite.

### Example 10

A first liquid and a second liquid were prepared in the same manner as that in Example 1 except that the added amounts of the spherical alumina and the amorphous alumina were increased.

### Example 11

A first liquid and a second liquid were prepared in the same manner as that in Example 1 except that aluminum hydroxide was used instead of the amorphous alumina. As the aluminum hydroxide, BW103 manufactured by Nippon Light Metal Co., Ltd. (average particle diameter: 10 μm) was used.

### Comparative Example 1

A first liquid and a second liquid were prepared in the same manner as that in Example 1 except that the expandable graphite of the component (E) was not contained.

### Comparative Example 2

A first liquid and a second liquid were prepared in the same manner as that in Example 6 except that microballoons were used instead of the expandable graphite of the component (E), and FN-190D manufactured by Matsumoto Yushi-Seiyaku Co., Ltd. (expansion start temperature: 190° C.) was used as the microballoon.

### Comparative Example 3

A first liquid and a second liquid were prepared in the same manner as that in Example 3 except that expanded graphite was added instead of the expandable graphite of the component (E). AED-50 manufactured by Fujikokuen Co., Ltd. was used as the expanded graphite.

### Comparative Example 4

A first liquid and a second liquid were prepared in the same manner as that in Example 6 except that expanded graphite was added instead of the expandable graphite of the component (E).

### Comparative Example 5

A first liquid and a second liquid were prepared in the same manner as that in Example 1 except that the added amount of the expandable graphite of the component (E) was changed to 20 parts by mass.

The evaluation results were as shown in Table 1.

In Examples 1 to 7, 0.5 to 5 parts by mass of the expandable graphite EXP-50HO (expandable graphite, expansion start temperature of 220° C.) was added as the component (E). In all examples, the shear adhesion strength before high temperature exposure was 0.1 MPa or more, and the shear adhesion strength after the exposure to a temperature of 250° C. for 1 hour was less than 0.1 MPa (0.08 MPa or less). It was thus confirmed that the product could be easily peeled off from the substrate after exposed to a high temperature while maintaining the good adhesive properties under the normal condition. Furthermore, all of them have the thermal conductivity of 2.0 W/m·k or more, indicating good thermal conductive properties. The volume resistivity was 10⁷ Ω·cm or more, indicating good electrical insulation properties. In Examples 6 and 7, 3 parts by mass and 5 parts by mass of the expandable graphite were blended, respectively. The viscosity increased but within the acceptable range.

In Example 8, the adhesion aid and the condensation catalyst are not added. The shear adhesion strength, which is low before high temperature exposure, becomes even lower after exposed to a high temperature due to the addition of the expandable graphite.

In Example 9 in which the expandable graphite EXP-50S160 with the expansion start temperature of 160° C. was added, it was confirmed that the product could be easily peeled off from the substrate after exposed to a high temperature while maintaining the good adhesive properties under the normal condition. Furthermore, the thermal conductivity was 2.0 W/m·k or more, indicating good thermal conductive properties. The volume resistivity was 10⁶ Ω·cm or more, indicating good electrical insulation properties.

In Example 10, the amount of alumina of the component (C) as the thermally conductive filler was increased. Although a high thermal conductivity of 2.8 W/m·k could be achieved as the thermal conductive properties, the viscosity increased to 150 Pa·s, which was considered poor in coating properties. However, it was confirmed that the product could be easily peeled off from the substrate after exposed to a high temperature while maintaining the good adhesive properties under the normal condition.

In Example 11 in which aluminum hydroxide was added instead of amorphous alumina, although the thermal conductivity decreased slightly, the low specific gravity of 2.88 could be achieved. Thus, this addition could contribute to weight reduction. Furthermore, it was confirmed that the product could be easily peeled off from the substrate after exposed to a high temperature while maintaining the good adhesive properties under the normal condition.

In Comparative example 1 in which the expandable graphite was not added, the product had good adhesive properties under the normal condition and a high shear adhesion strength even after the exposure to a temperature of 250° C. for 1 hour. It is conceivable that the product would not be easily peeled off from the substrate at a high temperature.

In Comparative example 2, microballoons that expanded at 160° C. was blended as the expandable graphite. It was confirmed that the microballoons expanded by heating like the expandable graphite and the composition could be easily peeled off from the substrate after exposed to a high temperature while maintaining the good adhesive properties under the normal condition. However, the microballoons with a hollow structure had the low thermal conductive properties by themselves. Thus, the resulting gap filler had the low thermal conductivity of 1.9 W/m·k.

In Comparative examples 3 and 4, expanded graphite was blended instead of the expandable graphite. Since the expanded graphite is graphite that has already expanded, the expanded graphite has the low cohesive force under the normal condition and thus has the low shear adhesion strength under the normal condition, which results in the insufficient adhesive properties to the substrate.

In Comparative example 5, 20 parts by mass of the expandable graphite was added. It was confirmed that the product could be easily peeled off from the substrate after exposed to a high temperature while maintaining the good adhesive properties under the normal condition. However, having the large amount of the electroconductive graphite decreases the volume resistivity, making it difficult to obtain the sufficient electrical insulation properties.

TABLE 1

| | | | Compar- | Compar- | Compar- | Compar- | Compar- | Exam- | Exam- | Exam- |
|---|---|---|---|---|---|---|---|---|---|---|
| | | | ative | ative | ative | ative | ative | ple 1 | ple 2 | ple 3 |
| First | Vi-Polymer | (A) | 100 | 100 | 100 | 100 | 100 | 100 | 100 | 100 |
| liquid | Alumina | (C)-1 | 300 | 300 | 300 | 300 | 300 | 300 | 300 | 300 |
| | (amorphous, 3 μm) | | | | | | | | | |
| | Alumina | (C)-2 | 500 | 500 | 500 | 500 | 500 | 500 | 500 | 500 |
| | (spherical, 45 μm) | | | | | | | | | |
| | Aluminum hydroxide | (C)-3 | | | | | | | | |
| | (amorphous, 10 μm) | | | | | | | | | |
| | Platinum catalyst | (D) | 1.5 | 1.5 | 1.5 | 1.5 | 1.5 | 1.5 | 1.5 | 1.5 |
| | Silane coupling agent | | 5 | 5 | 5 | 5 | 5 | 5 | 5 | 5 |
| | Condensation catalyst | | 0.5 | 0.5 | 0.5 | 0.5 | 0.5 | 0.5 | 0.5 | 0.5 |
| | Curing inhibitor | | 1 | 1 | 1 | 1 | 1 | 1 | 1 | 1 |
| | Color pigment | | 5 | 5 | 5 | 5 | 5 | 5 | 5 | 5 |
| | EXP-50HO (expandable | (E)-1 | | | | | 20 | 0.5 | 1 | 1.5 |
| | graphite, expansion | | | | | | | | | |
| | start 220° C.) | | | | | | | | | |
| | EXP-50S160 (expansion | (E)-2 | | | | | | | | |
| | start temperature | | | | | | | | | |
| | 160° C.) | | | | | | | | | |
| | AED-50 | | | | 1.5 | 3 | | | | |
| | (expanded graphite) | | | | | | | | | |
| | Matsumoto Microsphere | | | 3 | | | | | | |
| | FN-190D (expansion start | | | | | | | | | |
| | temperature 160° C.) | | | | | | | | | |
| Second | Vi-Polymer | (A) | 30 | 30 | 30 | 30 | 30 | 30 | 30 | 30 |
| liquid | H-Polymer | (B) | 70 | 70 | 70 | 70 | 70 | 70 | 70 | 70 |
| | Alumina | (C)-1 | 300 | 300 | 300 | 300 | 300 | 300 | 300 | 300 |
| | (amorphous, 3 μm) | | | | | | | | | |
| | Alumina | (C)-2 | 500 | 500 | 500 | 500 | 500 | 500 | 500 | 500 |
| | (spherical, 45 μm) | | | | | | | | | |
| | Aluminum hydroxide | (C)-3 | | | | | | | | |
| | (amorphous, 10 μm) | | | | | | | | | |
| | Silane coupling agent | | 5 | 5 | 5 | 5 | 5 | 5 | 5 | 5 |
| | Curing agent | | 3 | 3 | 3 | 3 | 3 | 3 | 3 | 3 |
| | Adhesion aid | | 2 | 2 | 2 | 2 | 2 | 2 | 2 | 2 |
| | EXP-50HO (expandable | (E)-1 | | | | | 20 | 0.5 | 1 | 1.5 |
| | graphite, expansion | | | | | | | | | |
| | start 220° C.) | | | | | | | | | |
| | EXP-50S160 expansion | (E)-2 | | | | | | | | |
| | start temperature | | | | | | | | | |
| | 160° C.) | | | | | | | | | |
| | AED-50 | | | | 1.5 | 3 | | | | |
| | (expanded graphite) | | | | | | | | | |
| | Matsumoto Microsphere | | | 3 | | | | | | |
| | FN-190D (expansion start | | | | | | | | | |
| | temperature 160° C.) | | | | | | | | | |
| | Thermal conductivity | | 2.2 | 1.9 | 2.0 | 1.9 | 2.3 | 2.2 | 2.2 | 2.2 |
| | (W/m · k) | | | | | | | | | |
| | Specific gravity | | 2.95 | 2.85 | 2.86 | 2.85 | 2.97 | 2.95 | 2.95 | 2.96 |
| | (before heating) | | | | | | | | | |
| | Specific gravity | | 2.97 | 2.8 | 2.89 | 2.89 | 3.02 | 2.92 | 2.91 | 2.92 |
| | (after heating) | | | | | | | | | |
| | Hardness | | 75 | 78 | 75 | 76 | 89 | 75 | 75 | 75 |
| | (Shore-00) | | | | | | | | | |
| | Mixed viscosity | | 80 | 115 | 101 | 113 | 143 | 86.5 | 86.5 | 89.2 |
| | 10S\hat{ }-1 (Pa · s) | | | | | | | | | |
| | Shear adhesion strength | | 0.12 | 0.09 | 0.08 | 0.07 | 0.10 | 0.13 | 0.12 | 0.12 |
| | (MPa) 23° C. 24 h | | | | | | | | | |
| | aluminum plate × | | | | | | | | | |
| | electrodeposition coated | | | | | | | | | |
| | steel plate 1.0 mm | | | | | | | | | |
| | Shear adhesion strength | | 0.13 | 0.08 | 0.07 | 0.07 | 0.07 | 0.08 | 0.07 | 0.06 |
| | (MPa) 250° C. 1 h | | | | | | | | | |
| | aluminum plate × | | | | | | | | | |
| | electrodeposition coated | | | | | | | | | |
| | steel plate 1.0 mm | | | | | | | | | |
| | Shear adhesion strength | | 1.08 | 0.89 | 0.88 | 1.00 | 0.70 | 0.62 | 0.58 | 0.52 |
| | change rate | | | | | | | | | |
| | (after heating/ | | | | | | | | | |
| | before heating) | | | | | | | | | |
| | Volume resistivity | | 10\hat{ }7 | 10\hat{ }7 | 10\hat{ }7 | 10\hat{ }7 | 10\hat{ }5 | 10\hat{ }7 | 10\hat{ }7 | 10\hat{ }7 |
| | (Ω · cm) IEC 60093 | | | | | | | | | |

| | | | Exam- | Exam- | Exam- | Exam- | Exam- | Exam- | Exam- | Exam- |
|---|---|---|---|---|---|---|---|---|---|---|
| | | | ple 4 | ple 5 | ple 6 | ple 7 | ple 8 | ple 9 | ple 10 | ple 11 |
| First | Vi-Polymer | (A) | 100 | 100 | 100 | 100 | 100 | 100 | 100 | 100 |
| liquid | Alumina | (C)-1 | 300 | 300 | 300 | 300 | 300 | 300 | 400 | |
| | (amorphous, 3 μm) | | | | | | | | | |
| | Alumina | (C)-2 | 500 | 500 | 500 | 500 | 500 | 500 | 800 | 500 |
| | (spherical, 45 μm) | | | | | | | | | |
| | Aluminum hydroxide | (C)-3 | | | | | | | | 300 |
| | (amorphous, 10 μm) | | | | | | | | | |
| | Platinum catalyst | (D) | 1.5 | 1.5 | 1.5 | 1.5 | 1.5 | 1.5 | 1.5 | 1.5 |
| | Silane coupling agent | | 5 | 5 | 5 | 5 | 5 | 5 | 5 | 5 |
| | Condensation catalyst | | 0.5 | 0.5 | 0.5 | 0.5 | | 0.5 | 0.5 | 0.5 |
| | Curing inhibitor | | 1 | 1 | 1 | 1 | 1 | 1 | 1 | 1 |
| | Color pigment | | 5 | 5 | 5 | 5 | 5 | 5 | 5 | 5 |
| | EXP-50HO (expandable | (E)-1 | 2 | 2.5 | 3 | 5 | 1.5 | | 0.5 | 0.5 |
| | graphite, expansion | | | | | | | | | |
| | start 220° C.) | | | | | | | | | |
| | EXP-50S160 (expansion | (E)-2 | | | | | | 1.5 | | |
| | start temperature | | | | | | | | | |
| | 160° C.) | | | | | | | | | |
| | AED-50 | | | | | | | | | |
| | (expanded graphite) | | | | | | | | | |
| | Matsumoto Microsphere | | | | | | | | | |
| | FN-190D (expansion | | | | | | | | | |
| | start temperature | | | | | | | | | |
| | 160° C.) | | | | | | | | | |
| Second | Vi-Polymer | (A) | 30 | 30 | 30 | 30 | 30 | 30 | 30 | 30 |
| liquid | H-Polymer | (B) | 70 | 70 | 70 | 70 | 70 | 70 | 70 | 70 |
| | Alumina | (C)-1 | 300 | 300 | 300 | 300 | 300 | 300 | 400 | |
| | (amorphous, 3 μm) | | | | | | | | | |
| | Alumina | (C)-2 | 500 | 500 | 500 | 500 | 500 | 500 | 800 | 500 |
| | (spherical, 45 μm) | | | | | | | | | |
| | Aluminum hydroxide | (C)-3 | | | | | | | | 300 |
| | (amorphous, 10 μm) | | | | | | | | | |
| | Silane coupling agent | | 5 | 5 | 5 | 5 | 5 | 5 | 5 | 5 |
| | Curing agent | | 3 | 3 | 3 | 3 | 3 | 3 | 3 | 3 |
| | Adhesion aid | | 2 | 2 | 2 | 2 | | 2 | 2 | 2 |
| | EXP-50HO (expandable | (E)-1 | 2 | 2.5 | 3 | 5 | 1.5 | | 0.5 | 0.5 |
| | graphite, expansion | | | | | | | | | |
| | start 220° C.) | | | | | | | | | |
| | EXP-50S160 expansion | (E)-2 | | | | | | 1.5 | | |
| | start temperature | | | | | | | | | |
| | 160° C.) | | | | | | | | | |
| | AED-50 | | | | | | | | | |
| | (expanded graphite) | | | | | | | | | |
| | Matsumoto Microsphere | | | | | | | | | |
| | FN-190D (expansion | | | | | | | | | |
| | start temperature | | | | | | | | | |
| | 160° C.) | | | | | | | | | |
| | Thermal conductivity | | 2.2 | 2.2 | 2.2 | 2.2 | 2.2 | 2.2 | 2.8 | 2.1 |
| | (W/m · k) | | | | | | | | | |
| | Specific gravity | | 2.96 | 2.96 | 2.97 | 2.97 | 2.96 | 2.96 | 3.05 | 2.88 |
| | (before heating) | | | | | | | | | |
| | Specific gravity | | 2.91 | 2.9 | 2.89 | 2.88 | 2.91 | 2.91 | 2.99 | 2.85 |
| | (after heating) | | | | | | | | | |
| | Hardness | | 75 | 75 | 77 | 77 | 75 | 75 | 92 | 80 |
| | (Shore-00) | | | | | | | | | |
| | Mixed viscosity | | 89.1 | 94.3 | 101.3 | 106.8 | 91.4 | 92 | 154 | 95.2 |
| | 10S\hat{ }-1 (Pa · s) | | | | | | | | | |
| | Shear adhesion strength | | 0.12 | 0.12 | 0.11 | 0.12 | 0.07 | 0.12 | 0.12 | 0.11 |
| | (MPa) 23° C. 24 h | | | | | | | | | |
| | aluminum plate × | | | | | | | | | |
| | electrodeposition coated | | | | | | | | | |
| | steel plate 1.0 mm | | | | | | | | | |
| | Shear adhesion strength | | 0.06 | 0.05 | 0.06 | 0.05 | 0.06 | 0.05 | 0.07 | 0.07 |
| | (MPa) 250° C. 1 h | | | | | | | | | |
| | aluminum plate × | | | | | | | | | |
| | electrodeposition coated | | | | | | | | | |
| | steel plate 1.0 mm | | | | | | | | | |
| | Shear adhesion strength | | 0.50 | 0.42 | 0.57 | 0.42 | 0.89 | 0.42 | 0.58 | 0.64 |
| | change rate | | | | | | | | | |
| | (after heating/ | | | | | | | | | |
| | before heating) | | | | | | | | | |
| | Volume resistivity | | 10\hat{ }7 | 10\hat{ }7 | 10\hat{ }7 | 10\hat{ }7 | 10\hat{ }7 | 10\hat{ }7 | 10\hat{ }7 | 10\hat{ }7 |
| | (Ω · cm) IEC 60093 | | | | | | | | | |

Part or all of the above-described embodiments may also be described as the following appendixes, but are not limited by the following description.

### (Appendix 1)

A thermally conductive composition containing:
a component (A) that is a diorganopolysiloxane having an alkenyl group bonded to a silicon atom;
a component (B) that is a diorganopolysiloxane having a hydrogen atom bonded to a silicon atom;
a component (C) that is expandable graphite;
a component (D) that is a thermally conductive filler; and
a component (E) that is an addition reaction catalyst, wherein
the content of the component (C) is 0.5 parts by mass or more and 5 parts by mass or less relative to 100 parts by mass of the total amount of the components (A) and (B), and
the content of the component (D) is 300 parts by mass or more and 2,000 parts by mass or less relative to 100 parts by mass of the total amount of the components (A) and (B).

### (Appendix 2)

The thermally conductive composition as set forth in Appendix 1, characterized in that the thermally conductive composition is a thermally conductive gap filler composition for forming a gap filler by applying the composition in a liquid state before curing to a substrate and then curing the composition.

### (Appendix 3)

The thermally conductive composition as set forth in Appendix 1 or 2, wherein the component (A) is a diorganopolysiloxane having an alkenyl group bonded to a silicon atom at both the molecular chain terminals.

### (Appendix 4)

The thermally conductive composition as set forth in any one of Appendixes 1 to 3, wherein the component (B) is a diorganopolysiloxane having a hydrogen atom bonded to a silicon atom at both the molecular chain terminals.

### (Appendix 5)

The thermally conductive composition as set forth in any one of Appendixes 1 to 4, wherein the thermally conductive composition has a viscosity in a range of 10 to 1,000 mPa·s as measured by a rotational viscometer before curing at a temperature of 25° C. and a shear rate of 10/s.

### (Appendix 6)

The thermally conductive composition as set forth in any one of Appendixes 1 to 5, wherein the thermally conductive composition has a volume resistivity of 1×10⁶ Ω·cm or more before curing.

### (Appendix 7)

The thermally conductive composition as set forth in any one of Appendixes 1 to 6, wherein an expansion rate (volume after high temperature exposure/volume before high temperature exposure) of the thermally conductive member obtained by curing the thermally conductive composition is 1.1 or less.

### (Appendix 8)

The thermally conductive composition as set forth in any one of Appendixes 1 to 7, wherein the component (C) is expandable graphite that generates an inorganic acid at a temperature of 100° C. or higher and 300° C. or lower.

### (Appendix 9)

The thermally conductive composition as set forth in Appendix 8, wherein the inorganic acid is one or more selected from the group consisting of sulfuric acid, nitric acid, and hydrochloric acid.

### (Appendix 10)

The thermally conductive composition as set forth in any one of Appendixes 1 to 9, wherein the component (D) is a non-electroconductive thermally conductive filler.

### (Appendix 11)

The thermally conductive composition as set forth in any one of Appendixes 1 to 10, wherein the thermally conductive filler of the component (D) contains at least one or more types selected from aluminum hydroxide and aluminum oxide.

### (Appendix 12)

The thermally conductive composition as set forth in any one of Appendixes 1 to 11, containing no organosilicon compound having one or more alkenyl groups and one or more alkoxy groups bonded to silicon atoms within one molecule.

1-17. (canceled)

18. A thermally conductive composition comprising:
a component (A) that is a diorganopolysiloxane having an alkenyl group bonded to a silicon atom;
a component (B) that is a diorganopolysiloxane having a hydrogen atom bonded to a silicon atom;
a component (C) that is expandable graphite;
a component (D) that is a thermally conductive filler; and
a component (E) that is an addition reaction catalyst,
an organosilicon compound or an organosiloxane (also referred to as a silane coupling agent) that produces silanols by hydrolysis and a condensation catalyst,
wherein the content of such silane coupling agent is used in an amount of one to three times as calculated by the following expression:
Required amount (g) of silane coupling agent=Weight (g) of filler×Specific surface area (m²/g)/minimal covering area specific to silane coupling agent (m²/g),
wherein
a content of the component (C) is 0.5 parts by mass or more and 3 parts by mass or less relative to 100 parts by mass of a total amount of the components (A) and (B), and
wherein an expansion rate (volume after high temperature exposure/volume before high temperature exposure) of a thermally conductive member obtained by curing the thermally conductive composition is 1.1 or less, and
a content of the component (D) is 300 parts by mass or more and 2,000 parts by mass or less relative to 100 parts by mass of the total amount of the components (A) and (B).

19. The thermally conductive composition according to claim 18, wherein the thermally conductive composition is a thermally conductive gap filler composition for forming a gap filler by applying the composition in a liquid state before curing to a substrate and then curing the composition.

20. The thermally conductive composition according to claim 18, wherein the component (A) is a diorganopolysiloxane having an alkenyl group bonded to a silicon atom at both molecular chain terminals.

21. The thermally conductive composition according to claim 18, wherein the component (B) is a diorganopolysiloxane having a hydrogen atom bonded to a silicon atom at both molecular chain terminals.

22. The thermally conductive composition according to claim 18, wherein the thermally conductive composition has a viscosity in a range of 10 to 1,000 mPa·s as measured by a rotational viscometer before curing at a temperature of 25° C. and a shear rate of 10/s.

23. The thermally conductive composition according to claim 18, wherein the thermally conductive composition has a volume resistivity of 1×10⁶ Ω·cm or more before curing.

24. The thermally conductive composition according to claim 18, wherein the component (C) is expandable graphite that generates an inorganic acid at a temperature of 100° C. or higher and 300° C. or lower.

25. The thermally conductive composition according to claim 24, wherein the inorganic acid is one or more selected from the group consisting of sulfuric acid, nitric acid, and hydrochloric acid.

26. The thermally conductive composition according to claim 18, wherein the component (D) is a non-electroconductive thermally conductive filler.

27. The thermally conductive composition according to claim 18, wherein the thermally conductive filler of the component (D) contains at least one or more types selected from aluminum hydroxide and aluminum oxide.

28. The thermally conductive composition according to claim 18, containing no organosilicon compound having one or more alkenyl groups and one or more alkoxy groups bonded to silicon atoms within one molecule.

29. A thermally conductive member obtained by curing the thermally conductive composition according to claim 18 and which has a thermal conductivity of 1 W/m·K or more at −30° C. to 80° C. and satisfies the following conditions (a) and (b):
(a) a shear adhesion strength of the thermally conductive member before heating measured by the following test is 0.1 MPa or more, and
(b) a shear adhesion strength of the thermally conductive member after heating at 250° C. for 1 hour or longer measured by the following test is less than 0.1 MPa,
Test: the thermally conductive composition is sandwiched between an aluminum plate and an electrodeposition-coated steel plate so as to have a coating thickness of 1 mm and is allowed to stand at room temperature for one day for curing, and then, a shear adhesion tensile test is performed at a tensile rate of 50 mm/min at room temperature using a tensile tester to measure a stress at break as the shear adhesion strength.

30. The thermally conductive member according to claim 29, wherein it is a gap filler.
